(19) United States
(12) Patent Application Publication
(10) Pub. No.: US 2026/0146884 A1
(43) Pub. Date: May 28, 2026

(54) HEATED TEMPERATURE PROBE AND METHOD OF USING IN A FRYER VAT

(71) Applicant: FRYMASTER LLC., New Port Richey, FL (US)

(72) Inventors: Jan Claesson, Land O' Lakes, FL (US); Austin Haddock, Shreveport, LA (US); Justin Baker, Shreveport, LA (US)

(73) Assignee: FRYMASTER LLC., New Port Richey, FL (US)

(21) Appl. No.: 19/348,308

(22) Filed: Oct. 2, 2025

Related U.S. Application Data
(60) Provisional application No. 63/702,340, filed on Oct. 2, 2024.

(51) Int. Cl. G01F 23/22; A47J 37/12; G01K 1/02; G01K 3/14

(52) U.S. Cl. CPC G01F 23/22; A47J 37/1266; A47J 37/1271; G01K 1/026; G01K 3/14; A47J 2202/00

(57) ABSTRACT

A heated temperature probe for placement in a fryer vat with fluid media disposed therein, the heated temperature probe comprises: a temperature sensor disposed about a tip of the heated temperature probe; a base section disposed about the opposite end of the heated temperature probe from the temperature sensor; and a heater disposed in the heated temperature probe between the temperature sensor and the base, wherein the heater transfers most of the temperature increase generated by the heater to the temperature sensor and less heat to the base.

### CROSS-REFERENCE TO RELATED APPLICATION

This application claims priority to U.S. Provisional Application No. 63/702,340, filed on Oct. 2, 2024, which is incorporated herein by reference thereto in its entirety.

### BACKGROUND

### 1. Field

The present disclosure pertains to a heated oil in back (OIB) temperature probe which is disposed in a fryer vat to determine if there is sufficient amount of fluid (e.g., oil) or insufficient amount for heating a fryer in a brief period of time. Additionally, the probe is also able to determine a specific level of such fluid. The probe of the present disclosure allows for a quick determination of the surrounding media and works both in heating and cooling of the fluid media.

### 2. Discussion of the Background Art

U.S. Pat. No. 9,357,881 (Gardner et al.) entitled “oil level detection system for deep fat fryer,” discloses a detector configured to indirectly monitor a level of liquid within a container. Gardner et al. discloses a liquid level detector disposed within a vat, the liquid level detector comprising a heat producing element and a temperature sensor disposed proximate to the heat producing element and configured to provide a first output signal representative of a surface temperature of the heat producing element.

FIG. 8 depicts a conventional temperature/fryer fluid level sensor circuit system 80 which requires a temperature sensor probe to reach a temperature of 570° F. to enable it to detect air, which might take 3-5 minutes from ambient temperature of the temperature sensor probe (not shown).

To the contrary, the present disclosure only heats a temperature sensor to 200° F. from ambient temperature, which might be just one quarter of the delta temperature as compared to the conventional system of FIG. 8. That is, the probe diameter of the present disclosure is typically just ⅓ of the diameter of probe in FIG. 8, which reduces the mass to approximately ⅛^{th}. Thus, by reducing the length of the heater, the present inventors have discovered that it reduces the mass that is required to be heated with a result of a heat-up time in the order of 20-30 seconds with only using an 8-watt heater instead of a 40-watter heater used in the sensor of FIG. 8.

Moreover, once the sensor of FIG. 8 is operated in a heated fryer vat at 350° F. with oil in it, the heater will run more in the temperature range of 450-500° F., which is accelerating the aging of the oil, while the present disclosure sensor will only operate close to 375° F., which is much less damaging to the oil.

The system in FIG. 8 is based on a cartridge heater and temperature sensor attached to the body of the cartridge heater, a temperature controller and a delay-on-make relay. The controller will control the cartridge heater to not exceed 570° F. If the cartridge heater is surrounded with air, it will start cycling once it has reached a temperature exceeding 570° F. As long as the on-time of the cartridge heater is less than the 7 second delay-on-make relay, the relay will prevent further heating by disconnecting the power to the gas valve. Due to the long heat-up time of the cartridge heater, one has to delay the heating of the vat since the system cannot evaluate if there is air or oil surrounding the cartridge heater. This delay cut in on production time especially every time one does a filtering of the oil that will empty the vat of oil.

Another technical problem of the conventional sensor probe shown in FIG. 8 is that the probe does not cool off very quickly and at each and every filtering of the oil, it tends to carbonize the oil due to heating in air. Such carbonization of the oil leads to a build-up on the probe itself, which generates a temperature insulating layer and typically generates an error, which required cleaning of the probe.

The probe of the present disclosure does not suffer from such carbonization layer. That is, the probe of the present disclosure will change the delta temperatures between the cooking probe 40 and heated temperature probe 2 as a function of the cooking probe temperature to compensate for viscosity and convection changes with the temperature of the oil.

The present disclosure also provides many additional advantages, which shall become apparent as described below.

### SUMMARY

A heated temperature probe for placement in a fryer vat with fluid media disposed therein, wherein said heated temperature probe comprises: a temperature sensor disposed about a tip of said heated temperature probe; a base section disposed about the opposite end of said heated temperature probe from said temperature sensor; and a heater disposed in said heated temperature probe between said temperature sensor and said base, wherein the heater transfers most of the temperature increase generated by said heater to said temperature sensor and less heat to said base.

The heater of said heated temperature probe will be controlled to maintain a temperature difference above the fluid media in said fryer vat based an additional temperature probe located in proximity to said heated temperature probe that measures the temperature of the fluid media.

The heated temperature probe further comprises a detector that measures the power consumption of the heater in the heated temperature probe that is required to maintain said temperature difference. The power consumption is used for evaluating the fluid media around the heated temperature probe and said fluid media's capability of removing heat from the heated temperature probe.

The presence of a water solution in the fryer can be determined when the heated temperature probe does not reach the desired temperature difference within a predetermined time period, even after the heater is providing 100% power.

A system for detecting the fluid media level in a fryer vat, said system comprising: a heated temperature probe mounted in said fryer vat, wherein said heated temperature probe comprises: a first temperature sensor disposed about a tip of said heated temperature probe; a base section disposed about the opposite end of said heated temperature probe from said first temperature sensor; and a heater disposed in said heated temperature probe between said first temperature sensor and said base, wherein the heater transfers most of the temperature increase generated by said heater to said first temperature sensor and less heat to said base; a second temperature sensor mounted within said fryer vat to measure said fluid temperature in said fryer vat, wherein said second temperature sensor probe is mounted in said fryer vat at a lower or equal level as said first temperature sensor; a heater controller connected to said first temperature sensor and said second temperature sensor, wherein said heater controller controls the heater based on the difference between T1 temperature measured via said first temperature sensor and T2 temperature measured by second temperature sensor which detects the temperature of said fryer vat and controls said heater.

The heater controller is based on a temperature difference between T1 of said first temperature sensor and T2 of said second temperature sensor, wherein said heater controller is seeking to maintain a predetermined temperature difference using said temperature difference between T1 of said first temperature sensor and T2 of said second temperature sensor.

A heated temperature probe for placement in a fryer vat with fluid media disposed therein, said heated temperature probe comprises: a first temperature sensor disposed about a tip of said heated temperature probe; a base section disposed about the opposite end of said heated temperature probe from said first temperature sensor; a heater disposed in said heated temperature probe between said first temperature sensor and said base; and a second temperature sensor disposed opposite of said heater to said first temperature sensor and in proximity to said base section, wherein said second temperature sensor determines the temperature of said fluid media in said fryer vat; wherein the heater transfers most of the temperature increase generated by said heater to said first temperature sensor and less heat to said second temperature sensor.

A method for detecting the fluid media level in a fryer vat, said method comprising the steps of: determining a first temperature T1 by a heated temperature probe mounted in said fryer vat, wherein said heated temperature probe comprises a first temperature sensor disposed about a tip of said heated temperature probe; a base section disposed about the opposite end of said heated temperature probe from said first temperature sensor; and a heater disposed in said heated temperature probe between said first temperature sensor and said base, wherein the heater transfers most of the temperature increase generated by said heater to said first temperature sensor and less heat to said base; determining a second temperature T2 by a second temperature sensor which is mounted within said fryer vat to measure said fluid temperature in said fryer vat, said second temperature sensor probe is mounted in said fryer vat at a lower or equal level as said first temperature sensor; and controlling a heater via a heater controller which is connected to said first temperature sensor and said second temperature sensor, wherein said heater controller controls the heater based on the difference between T1 temperature measured via said first temperature sensor and T2 temperature measured by second temperature sensor which detects the temperature of said fryer vat.

The method further comprises controlling the heater of said heated temperature probe to maintain a temperature difference above the fluid media in said fryer vat based an additional temperature probe located in proximity to said heated temperature probe that measures the temperature of the fluid media.

The method further comprises maintaining said temperature difference via a detector that measures power consumption of the heater in the heated temperature probe.

The method further comprises evaluating the power consumption to detect the fluid media around the heated temperature probe and said fluid media's capability of removing heat from the heated temperature probe.

The method further comprises determining the presence of a water solution surrounding said heated temperature probe if the temperature difference within a predetermined time period after the heater is providing 100% power is not reached.

The determination of the type of media surrounding the probe is then based on the power required to maintain said temperature difference. This can be done by observing the PWM signal used for controlling the probe heater to the predetermined temperature difference based on the cooking probe 40 measured temperature.

The power of the probe heater will represent the heat losses of the probe once it reaches equilibrium with the media surrounding the probe. Since cooking oil changes its viscosity etc. with temperature, the present inventors found that it gives a better sensitivity by increasing the temperature difference between the heated probe and the cooking probe 40 for lower temperatures where the oil is providing much less cooling of the heated temperature probe per degree F of temperature difference between the oil and the probe. An alternative way is to keep the temperature difference between the heated temperature probe and the cooking probe 40 constant and independent of the temperature of the cooking probe. However, then it might be necessary to change the evaluation criteria of the power required to maintain the temperature difference based on the temperature of the media surrounding the heated temperature probe.

A heated temperature probe for placement in a fryer vat with fluid media disposed therein, wherein the heated temperature probe comprises: a temperature sensor disposed about a tip of the heated temperature probe; a base section disposed about the opposite end of the heated temperature probe from the first temperature sensor; a heater disposed in the heated temperature probe between the first temperature sensor and the base; and a second temperature sensor disposed opposite of the heater to the first temperature sensor and in proximity to the base section, wherein the second temperature sensor determines the temperature of the fluid media in the fryer vat; wherein the heater transfers most of the temperature increase generated by the heater to the first temperature sensor and less heat to the second temperature sensor.

Further objects, features and advantages of the present disclosure will be understood by reference to the following drawings and detailed description.

### BRIEF DESCRIPTION OF THE DRAWINGS

FIG. 1 depicts a heated temperature probe according to an embodiment of the present disclosure, wherein only a single OIB or heated temperature sensor is disposed therein.

FIG. 2 depicts a hexagonal shaped base nut disposed between a cartridge shell encapsulating a heater and sensor, and the back-end thermal couple wires connected to a power source.

FIG. 3 depicts an alternative embodiment of the present disclosure, wherein a single probe includes first and second temperature sensors which are disposed about the cartridge shell such that a heater is disposed nearest the temperature sensor in the tip portion of the shell, but between both the first and second temperature sensors in a cartridge shell.

FIG. 4 is a fryer vat wherein a heated temperature probe according to FIG. 1 or 3 is disposed within the vat, together with a cook probe which is placed at a lower or equal level then the heated temperature probe.

FIG. 5 is a logic flow diagram used to control the vat heater using the heated temperature probe of the present disclosure.

FIG. 6 is a diagram depicting a controller according to the present disclosure which measures the difference between T1 (temperature of the heated temperature probe) and T2 (temperature of the fryer vat).

FIG. 7A is a block flow diagram according to the present disclosure depicted in FIGS. 1 and 4, respectively.

FIG. 7B is a block flow diagram according to the present disclosure depicted in FIGS. 1 and 3, respectively.

FIG. 8 is an electrical circuit diagram of a conventional 40 watt heater and thermostat in conjunction with a double-pole double-throw (DPDT) time delay relay (7 second), together with some simple logic to determine if there is oil/water in the fryer vat or simply air.

### DETAILED DESCRIPTION OF THE PREFERRED EMBODIMENT

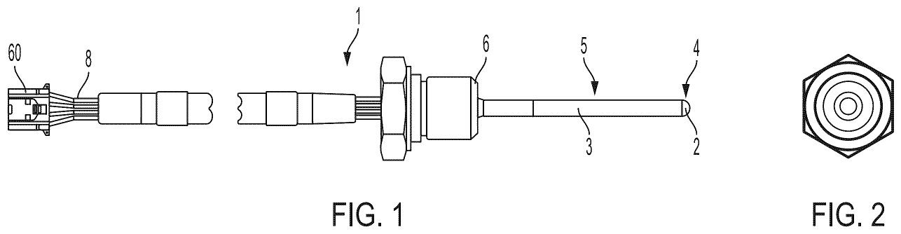

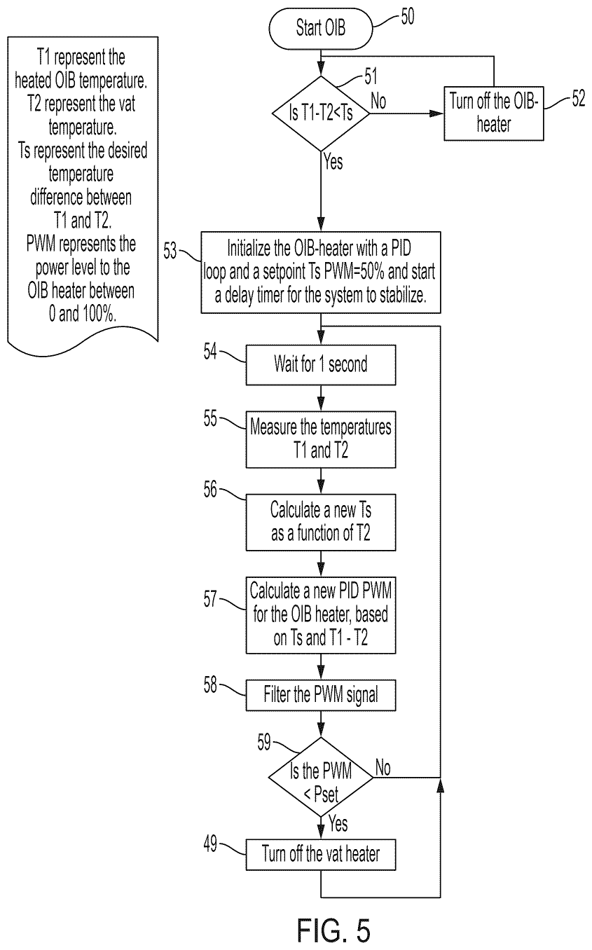

The present disclosure can best be described by referring to the figures, wherein FIG. 1 depicts a heated temperature probe 1 where one OIB temperature sensor 2 is incorporated into a small cartridge heater 3 where the temperature sensor 2 is placed in proximity of a heater 3 and preferably welded to tip 4 of cartridge shell or heated temperature probe 5. That way the heated part of cartridge shell or probe 5 transfers most of the temperature increase generated by heater 3 to first temperature sensor 2 and less heat to base 6 of cartridge shell or probe 5. Much of the heat will be dissipated by the surroundings of cartridge shell or probe 5, especially when cartridge shell probe 5 is submerged in a fluid. As shown in FIG. 4, a second temperature sensor probe 40 is mounted within fryer vat 41. Second temperature sensor probe 40 needs to measure the fluid temperature in vat 41 and should be placed at a lower or equal level as the first temperature sensor 2. Sensor and heater wires 8 connect first temperature sensor 2 through base 6 to heater controller 60. Also shown in FIG. 4 are automatic top-off probe 42, AIF (Automatic Intermittent Filtration) probe 43, and hi-limit probe 44.

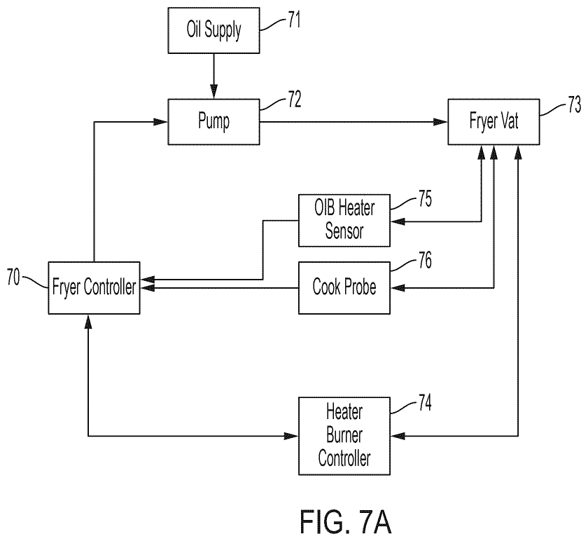

As shown in FIG. 6, heater controller 60 is based on the difference between T1 temperature detected via first temperature sensor 2 and T2 temperature detected by second temperature sensor 64 disposed in cooking probe 40. Cartridge shell probe 5 comprises first temperature sensor 2 and heater 3, wherein heater controller 60—and 24-volt power source 61 controls solid state switch 62 by means of a pulse width modulation (PWM) 63. That is, pulse width modulator 63 or PWM is a commonly used control technique that generates analog signals from digital devices such as microcontrollers. The signal thus produced will have a train of pulses, and these pulses will be in the form of square waves. Thus, at any given time, the wave will either be high or low and used to actuate heater 3.

Heater controller 60 controls the heater 3 based on the temperature difference between OIB temperature sensor 2 and second temperature sensor 64 (i.e., cooking probe 40), where heater controller 60 is trying to maintain a predetermined temperature difference (e.g., 25° F.) using the temperature difference of first temperature sensor 2 and second temperature sensor 64. The fluid media will be characterized and determined by how much power is required to maintain the temperature difference between sensors. Since oil has a large viscosity and density temperature dependency, the evaluating algorithm should compensate for the fluid temperature for best result. If the 1^{st} probe 2 (heater and sensor) is suspended in air, it will require very little power to maintain the temperature difference. On the other hand, if first probe 2 (with heater and sensor) is suspended in oil, it will require low to medium power level to maintain the temperature difference. On the other hand, if first probe 2 is submersed in water, it is unlikely that the heater is powerful enough to drive the predetermined temperature difference.

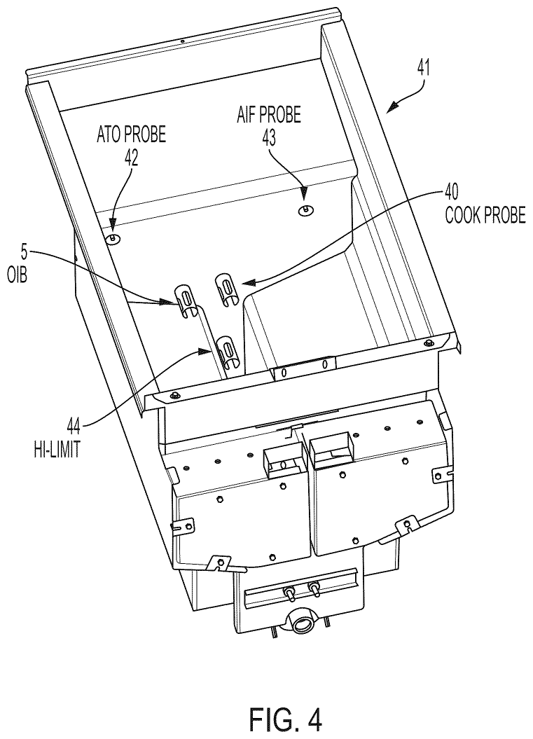

FIG. 3 depicts an alternative embodiment according to the present disclosure, wherein instead of controlling the heater 3 to a delta temperature difference and evaluating the power required to achieve such temperature difference between a first temperature sensor 2 and second temperature sensor 7 in as shown in FIG. 3, one can maintain a certain power level and evaluate the temperature difference by incorporating a first temperature sensor 2 and a second temperature sensor 7 on a single a heated temperature probe 10. That is, probe 10 might be reduced to a single probe with a first temperature sensor 2 disposed in tip 4, heater 3 disposed near sensor 2, while disposed between sensor 2 and second temperature sensor 7 located near base 6. Thermal couple wires 8 connect first temperature sensor 2 and second temperature sensor 7 through base 6 to heater controller 60.

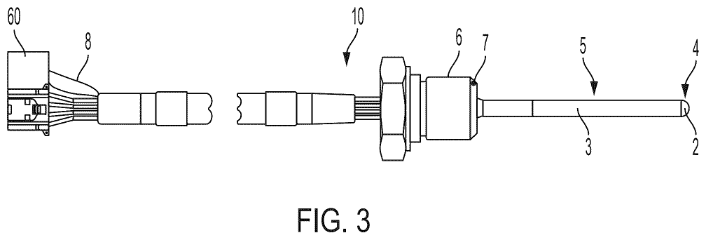

FIG. 2 depicts a hexagonal shaped base with threads is disposed between a cartridge shell encapsulating a heater and sensor, and the back-end thermal couple and heater wires connected to a controller and power source.

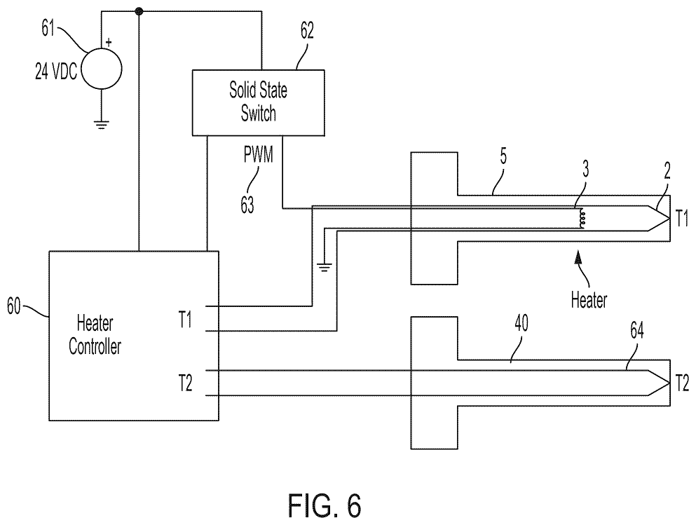

FIG. 5 is a logic flow diagram used to control the vat heater using the heated temperature probe of the present disclosure. Heater controller 60 includes the process flow conducted by first temperature sensor 2 and second temperature sensor 64 from FIG. 6, wherein T1 represents the heated temperature probe from first temperature sensor 2, and T2 represents the vat temperature from second temperature sensor 64. Ts represented the desired temperature difference between T1 and T2. Pulse width modulator (PWM) represents the power level sent to heater 3 between 0 and 100%.

First step 50 is to start heater 3 and then check to determine if T1-T2 is less than Ts 51. If Ts is not less than T1-T2, then heater 3 is turned off 52 and turned to step 51. If Ts is less than T1-T2, heater 3 is initialized with a PID control loop and a set point Ts, PWM is equal to 50% and the system starts a delay timer to stabilize 53. The system then waits for 1 second 54, measures the temperatures T1 and T2 55, calculates a new Ts as a function of T2 56, calculates a new PID and PWM for heater 3, based on Ts and T1-T2 57 and filters the PWM signal 58. Thereafter, the system determines if the PWM is less than Pset 59. If PWM is not less than Pset, then it returns to step 54. If PWM is less than Pset, then the vat heater (not shown) is turned off 49.

The Ts is the temperature increase to which the inventors are trying to control the heater 3. The required power to maintain the temperature increase Ts depends on the viscosity, heat-conductivity and the thermal expansion of the fluid media that is surrounding heated temperature probe 5 which comprises heater 3 and first temperature sensor 2 represents T1.

One of the main fluids that the inventors would like to recognize is deep-frying oil including solid shortening. Even the liquid frying oil changes viscosity strongly with temperature of the oil. To compensate for the viscosity changes, we change the value of the Ts, where the Ts will be a function of the vat temperature T2, where the Ts will be reduced with temperature.

Another fluid of interest is a water solution, where the heater in the heated temperature probe may not be able to reach the delta Ts as determined by the control loop. The evaluation of surrounding fluid will be determined after a predetermined time period after the heater is provided 100% power and not reaching the delta Ts or the derivative of the temperature has a small derivative (temperature rise).

To get a consistent heat out of heater 3, we are using regulated 24 VDC 61 as the power source that is switched on and off rapidly with a pulse width modulation (PWM) 63 solid state switch 62.

Heater 3 is located towards the tip of probe 5 which has a shell made of a thin-walled low thermal conductivity material to reduce the heat transfer to probe base 6, since we cannot determine the heat losses to the fluid versus conductive heat losses, whereby keeping the conductive losses to base 6 low will provide a more sensitive measuring system.

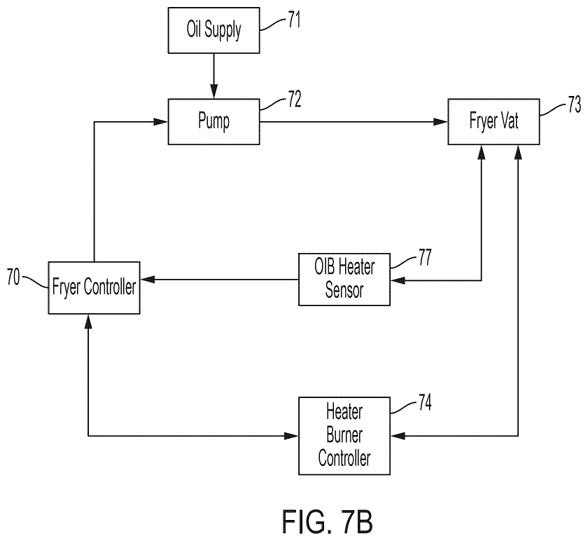

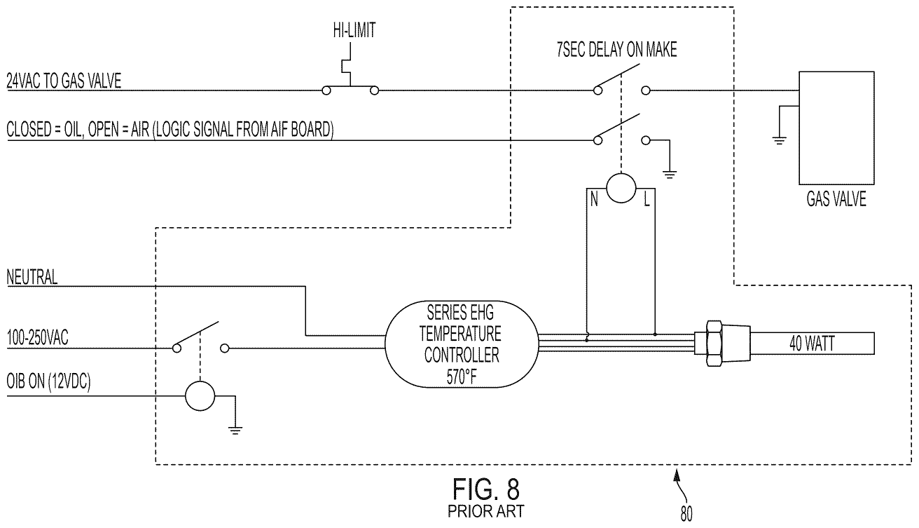

FIG. 7A is a block flow diagram according to the present disclosure depicted in FIGS. 1 and 4, respectively. According to one embodiment of the present disclosure, a fryer controller 70 pumps oil from oil supply 71 via pump 72 to fryer vat 73 and sends instructions to heater burner controller 74 to heat the oil in fryer vat 73. Thereafter, first heater sensor 75 measures T1 and cook probe 76 measures T2, i.e., the temperature of the vat fluid media, and sends T1 and T2 to fryer controller 70 to determine Ts.

FIG. 7B is a block flow diagram according to the second embodiment of the present disclosure depicted in FIGS. 1 and 3, respectively. That is heater sensor 77 includes a first temperature sensor 2 and a second temperature sensor 7 on a single a heated temperature probe 10 as shown in FIG. 3, wherein the power level and temperature difference can be evaluated.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A heated temperature probe for placement in a fryer vat with fluid media disposed therein, said heated temperature probe comprises:
a temperature sensor disposed about a tip of said heated temperature probe;
a base section disposed about the opposite end of said heated temperature probe from said temperature sensor; and
a heater disposed in said heated temperature probe between said temperature sensor and said base,
wherein the heater transfers most of the temperature increase generated by said heater to said temperature sensor and less heat to said base.

2. The heated temperature probe according to claim 1, where the heater of said heated temperature probe will be controlled to maintain a temperature difference above the fluid media in said fryer vat based an additional temperature probe located in proximity to said heated temperature probe that measures the temperature of the fluid media.

3. The heated temperature probe according to claim 2, further comprises a detector that measures power consumption of the heater in the heated temperature probe which is required to maintain said temperature difference.

4. The heated temperature probe according to claim 3, wherein the power consumption is used for evaluating the fluid media surrounding the heated temperature probe and said fluid media's capability of removing heat from the heated temperature probe.

5. The heated temperature probe according to claim 4, wherein water solution can be determined due to the heated temperature probe not reaching the temperature difference within a predetermined time period after the heater is providing 100% power.

6. A system for detecting the fluid media level in a fryer vat, said system comprising:
a heated temperature probe mounted in said fryer vat, wherein said heated temperature probe comprises: a first temperature sensor disposed about a tip of said heated temperature probe; a base section disposed about the opposite end of said heated temperature probe from said first temperature sensor; and a heater disposed in said heated temperature probe between said first temperature sensor and said base, wherein the heater transfers most of the temperature increase generated by said heater to said first temperature sensor and less heat to said base;
a second temperature sensor mounted within said fryer vat to measure said fluid temperature in said fryer vat, wherein said second temperature sensor probe is mounted in said fryer vat at a lower or equal level as said first temperature sensor; and
a heater controller connected to said first temperature sensor and said second temperature sensor, wherein said heater controller controls the heater based on the difference between T1 temperature measured via said first temperature sensor and T2 temperature measured by second temperature sensor which detects the temperature of said fryer vat and controls said heater.

7. The system according to claim 6, wherein said heater controller is based on a temperature difference between T1 of said first temperature sensor and T2 of said second temperature sensor, wherein said heater controller is seeking to maintain a predetermined temperature difference using said temperature difference between T1 of said first temperature sensor and T2 of said second temperature sensor.

8. A heated temperature probe for placement in a fryer vat with fluid media disposed therein, said heated temperature probe comprises:
a first temperature sensor disposed about a tip of said heated temperature probe;
a base section disposed about the opposite end of said heated temperature probe from said first temperature sensor;
a heater disposed in said heated temperature probe between said first temperature sensor and said base; and
a second temperature sensor disposed opposite of said heater to said first temperature sensor and in proximity to said base section, wherein said second temperature sensor determines the temperature of said fluid media in said fryer vat;
wherein the heater transfers most of the temperature increase generated by said heater to said first temperature sensor and less heat to said second temperature sensor.

9. A method for detecting the fluid media level in a fryer vat; said system comprising:
determining a first temperature T1 by a heated temperature probe mounted in said fryer vat, wherein said heated temperature probe comprises a first temperature sensor disposed about a tip of said heated temperature probe; a base section disposed about the opposite end of said heated temperature probe from said first temperature sensor; and a heater disposed in said heated temperature probe between said first temperature sensor and said base, wherein the heater transfers most of the temperature increase generated by said heater to said first temperature sensor and less heat to said base;
determining a second temperature T2 by a second temperature sensor which is mounted within said fryer vat to measure said fluid temperature in said fryer vat, said second temperature sensor probe is mounted in said fryer vat at a lower or equal level as said first temperature sensor; and
controlling a heater via a heater controller with is connected to said first temperature sensor and said second temperature sensor, wherein said heater controller controls the heater based on the difference between T1 temperature measured via said first temperature sensor and T2 temperature measured by second temperature sensor which detects the temperature of said fryer vat.

10. The method according to claim 9, further comprising controlling the heater of said heated temperature probe to maintain a temperature difference above the fluid media in said fryer vat based an additional temperature probe located in proximity to said heated temperature probe that measures the temperature of the fluid media.

11. The method according to claim 10, further comprising maintaining said temperature difference via a detector that measures power consumption of the heater in the heated temperature probe.

12. The method according to claim 11, further comprising evaluating the power consumption to detect the fluid media surrounding the heated temperature probe and said fluid media's capability of removing heat from the heated temperature probe.

13. The method according to claim 12, further comprising determining the fluid media as water solution surrounding said heated temperature probe if the temperature difference within a predetermine time period after the heater is providing 100% power is not reached.
